(19) United States
(12) Patent Application Publication
(10) Pub. No.: US 2004/0051262 A1
(43) Pub. Date: Mar. 18, 2004

(54) Sled apparatus

(76) Inventor: Melvin R. Young, King George, VA (US)

Correspondence Address: LAW OFFICES OF WILLIAM L. KLIMA, P.C., P.O. Box 2855, Stafford, VA, 22555-2855, US

(21) Appl. No.: 10/241,460

(22) Filed: Sep. 12, 2002

(51) Int. Cl. B62K 13/00

(52) U.S. Cl. 280/7.12

(57) ABSTRACT

The present invention is directed to a sled apparatus. In preferred embodiments of the present invention, the sled apparatus is configured to move over various types of surfaces including the ground, grass, pavement, concrete, asphalt, snow, ice, and artificial surfaces.

### FIELD OF THE INVENTION

The present invention is directed to a sled apparatus. In preferred embodiments of the present invention, the sled apparatus is configured to move over various types of surfaces including the ground, dirt, grass, pavement, concrete, asphalt, snow, ice, and artificial surfaces.

### BACKGROUND OF THE INVENTION

Presently there exists a wide variety of sporting equipment configured to be ridden. For example, there exists bicycles, scooters, roller skates, roller blades, skateboards, luges, street luges, skeletons, bobsleds and other sporting equipment configured for accommodating one or more riders. Most of these different types of sport equipment have been around for many years, and have been significantly developed, refined and established.

With the current significant interest in sports and athletics, there appears to be a real opportunity for new types of sport and recreational type equipment. Further, equipment of this type that can be ridden by a user may be of particular interest to persons looking for a new recreation or sporting experience.

### SUMMARY OF THE INVENTION

An object of the present invention is to provide a novel sled apparatus.

A second object of the present invention is to provide an improved sled apparatus.

A third object of the present invention is to provide a sled apparatus configured to tilt relative to a riding surface along at least one axis of the sled apparatus, preferably the roll axis.

A fourth object of the present invention is to provide a sled apparatus including a sled body configured to accommodate at least one rider, a front independent suspension connected to the sled body, a rear suspension connected to the sled body, a front pair of surface contacting members independently connected to the sled body by the front independent suspension, at least one surface contacting member independently connected to the sled body by the rear independent suspension, a steering mechanism configured to steer at least one of the surface contacting members, and a tilting mechanism configured to tilt the sled body along the sled body's roll axis relative to the ground.

A fifth object of the present invention is to provide a sled apparatus configured to have multiple surface contacting members including at least one selected from the group consisting of ski, ice skate, roller type blade and skid.

A sixth object of the present invention is to provide a sled apparatus including a front independent suspension configured for connecting a front pair of surface contacting members with a sled body of the sled apparatus.

A seventh object of the present invention is to provide a sled apparatus including a rear independent suspension supporting at least one surface contacting member.

An eighth object of the present invention is to provide a sled apparatus including a steering mechanism coupled with a tilting mechanism configured to provide a coordinated turning and tilting of the apparatus during negotiation of a turn with the sled apparatus.

The present invention is directed to a sled apparatus for use on various surfaces. The sled apparatus according to the present invention can be used on surfaces including, but not limited to the ground, dirt, sand, grass, vegetation, rocks, carpeted, tiled, pavement, asphalt, cement, ice, snow, or other suitable surfaces. Preferably the surface is inclined for unpowered embodiments of the sled apparatus according to the present invention, however, substantially flat surfaces can be utilized with powered embodiments of the sled apparatus according to the present invention.

The sled apparatus according to the present invention includes a sled body configured to accommodate at least one person. The sled body can be manufactured by a wide variety of methods depending on particular configurations and applications. For example, the sled body can be made of a welded tubular frame supporting an outer skin, cover or shell made of metal, plastic, fiberglass, Kevlar, graphite, composite material, aluminum sheeting, steel sheeting, or other suitable materials. Alternatively, the sled body can be constructed similar to modern jet liners having a monocock type structure with most or all of the structural strength located in the outer panel or perimeter of the sled body (e.g. aluminum or titanium slats supported by one or more bulkheads with an outer sheeting of material mechanically fastened, adhered, welded or otherwise connected to the slats). Alternatively, the entire sled body can be molded (e.g. injection molded or vacuum formed) or made in a fiberglass or composite material mold and laid up therein, with or without vacuum bagging, with bulkheads or gussets used to reinforce connections with mechanical components or equipment such as the front and rear suspensions, seat(s), foot pedal attachments with reinforcement spars adding structural strength along the longitudinal dimension of the sled apparatus.

The sled apparatus according to the present invention can have various wheel configurations including two (2) front wheels and two (2) rear wheels. Alternatively, the sled apparatus can include a single front wheel and a pair of rear wheels. In a preferred embodiment, there exists two (2) front wheels and a single rear wheel. For example, the rear wheel can be located centered along a center longitudinal axis of the sled apparatus and can be configured to be steerable or freely rotate or “free wheel” with the front two (2) wheels are steerable.

Preferably, the front wheel(s) and rear wheel(s) are provided with a suspension configured to accommodate a smooth surface in some applications (e.g. pavement or cement) or handle rough surfaces such as a grass covered ski slope on a mountain or hill during the summer. Thus, the desirable suspension is provided with a significant travel to accommodate substantially large bumps, trenches, divots, holes, ridges and other rough surface terrain that may be encountered during such use. Preferably, the suspensions for each surface contacting element is fully independent and includes spring elements (e.g. coil spring, leaf spring) and dampening elements (e.g. shock absorber or other suitable dampener). In a preferred embodiment, a transverse leaf spring is utilized to provide an independent suspension to two (2) front surface contacting elements and a coil spring in combination with a shock absorber is utilized in the suspension for a single trailing rear surface contacting element.

The sled apparatus according to the present invention can use a wide variety of surface contacting elements, including but not limited to wheels, ice skates, skis, skids, sled runners, roller skate type wheels, rollerblade type wheels and/or blade assemblies, rollers, combination of rollers or other suitable type surface contacting elements. In any event, the proper surface contacting elements must be selected for use depending on the particular applications and surfaces on which the sled apparatus is to be used. Further, the sled apparatus can be fitted with the same surface contacting elements (e.g. all rollerblade type wheels and blade assemblies) or can potentially utilize different surface contacting elements (e.g. pair of front skis and a single rear sled runner, or a pair of front rollerblade wheel blade assemblies and a single rear pneumatic tire and wheel).

The sled apparatus according to the present invention is preferably provided with steering. Specifically, at least one of the surface contacting elements is configured to be turned by a steering mechanism controlled by the rider of the sled apparatus. Preferably, two or more of the surface contacting elements are configured to steer the sled apparatus in a coordinated manner. For example, a front pair of surface contacting elements are configured to turn in the same direction in unison based on the configuration and arrangement of the steering mechanism. Optionally, a single rear surface contacting element is also coupled with the front surface contacting elements to provide an even more effective steering arrangement. The steering mechanism can be configured to be operated by a single foot, both feet, a single hand, both hands, a steering wheel, a steering lever, or a combination thereof.

The sled apparatus according to the present invention is preferably configured to rotate or tilt along at least one (1) major axis of the sled apparatus (e.g. roll axis, pitch axis and yaw axis). In a more preferred embodiment, the steering mechanism is coupled (e.g. mechanically, pneumatically, hydraulically) with the tilting mechanism to provide coordinated turning of the sled apparatus. In a most preferred embodiment, the tilting mechanism is configured to move the center of gravity of the sled apparatus sideways to the left or right side of the sled apparatus while steering to the left or right so that the center of gravity is moved towards the uphill side of the sled apparatus to provide a more effective and safe turning of the sled apparatus.

### BRIEF DESCRIPTION OF THE DRAWINGS

FIG. 1 is a perspective view of an embodiment of the sled apparatus according to the present invention.

FIG. 2 is a side elevational view of the sled apparatus according to the present invention shown in FIG. 1.

FIG. 3 is a top planar view of the sled apparatus according to the present invention shown in FIG. 1.

FIG. 4 is a front elevational view of the sled apparatus according to the present invention shown in FIG. 1.

FIG. 5 is a perspective view of the frame assembly, front suspension, rear suspension, steering assembly and pedal assembly of the sled apparatus shown in FIG. 1, without a skin or shell covering the frame assembly.

FIG. 6 is a front elevational frame of the frame assembly shown in FIG. 5.

FIG. 7 is a detailed perspective view of the front wheel suspension of the sled apparatus shown in FIGS. 1 and 5.

FIG. 8 is a detailed perspective view of the rear suspension of the sled apparatus shown in FIGS. 1 and 5.

FIG. 9 is a top diagrammatic view of the steering mechanism for the sled apparatus shown in FIGS. 1 and 5.

FIG. 10 is a side diagrammatic view of the steering mechanism shown in FIG. 9.

FIG. 11 is a perspective view of the steering mechanism shown in FIGS. 9 and 10.

FIG. 12 is another perspective view of the front wheel suspension shown in FIG. 7.

FIG. 13 is a perspective view of another embodiment of the sled apparatus according to the present invention having a pair of front roller blade assemblies and a single rear wheel.

FIG. 14 is a perspective view of a further embodiment of the sled apparatus according to the present invention having a front pair of skis and a single rear ski.

FIG. 15 is a perspective view of another further embodiment of the sled apparatus according to the present invention having a front pair of ice blades and a single rear ice blade.

FIG. 16 is a perspective view of an even further embodiment of the sled apparatus according to the present invention having a front pair of wheels and a single rear wheel.

FIG. 17 is a perspective view of even another embodiment of the sled apparatus according to the present invention having a front pair of wheels and a single rear roller blade assembly.

FIG. 18 is a perspective view of even another further embodiment of the sled apparatus according tot he present invention having a front pair of roller tracks and a single rear roller track.

FIG. 19 is a front elevational view of the sled apparatus shown in FIGS. 1 and 2 traveling tilted on a horizontal surface.

FIG. 20 is a front elevational view of the sled apparatus shown in FIGS. 1 and 2 traveling tilted on an inclined surface.

### DETAILED DESCRIPTION OF PREFERRED EMBODIMENTS

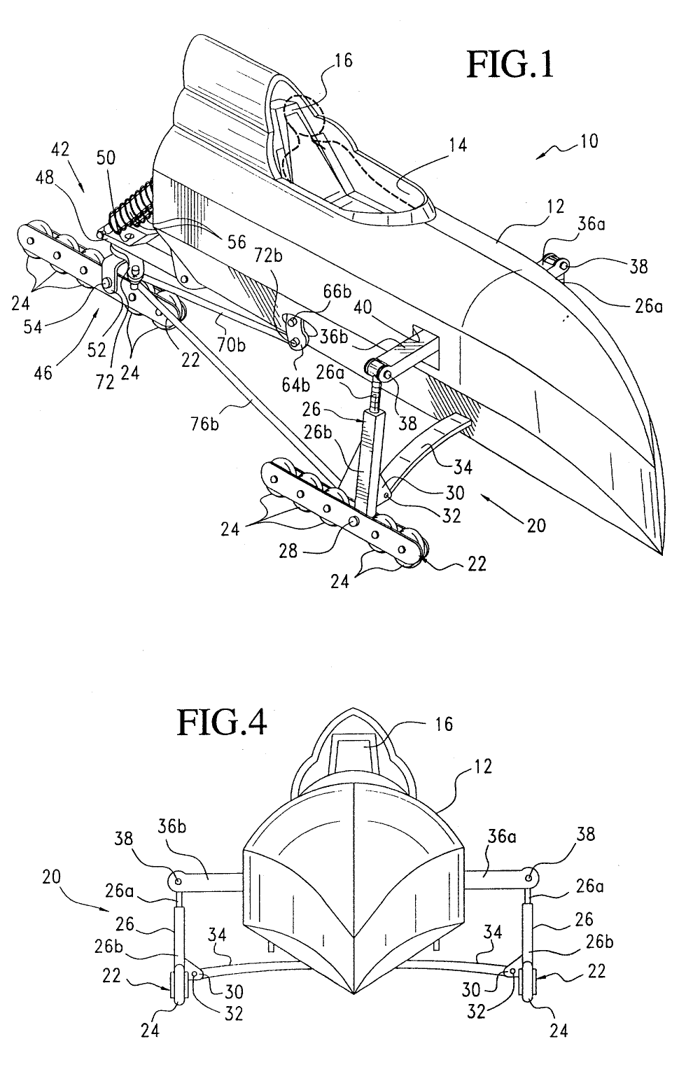

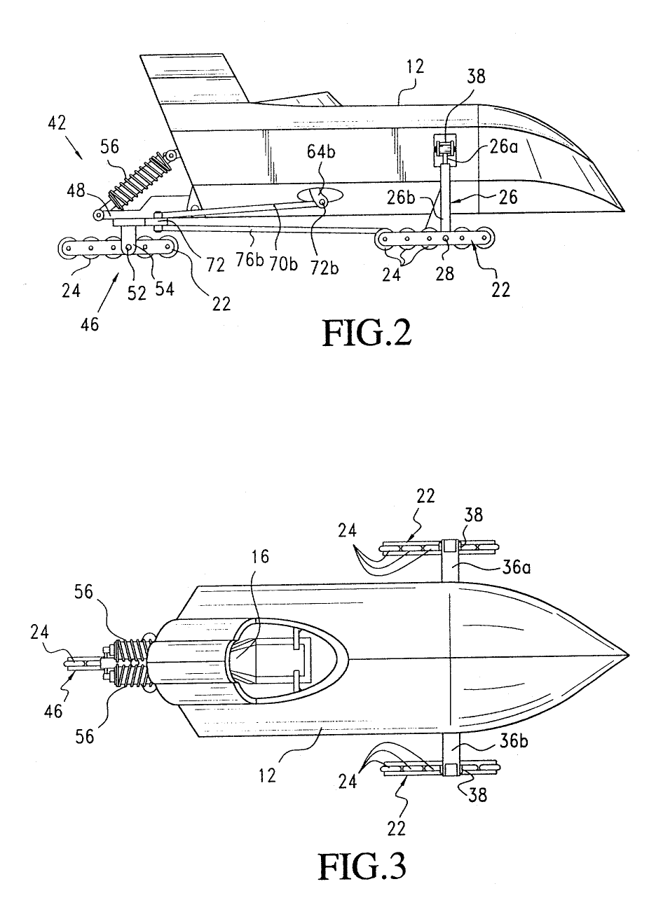

A sled apparatus 10 according to the present invention is shown in FIGS. 1-4.

The sled apparatus 10 includes a sled body 12 having a cockpit 14 provided with a seat 16 for accommodating a driver 18.

The sled body 12 is provided with a front suspension 20 for supporting a pair of rollerblade type blade assemblies 22 fitted with a plurality of rollerblade type wheels 24. For example, the rollerblade type blade assemblies 22 can each be provided with a set of three (3) wheels 24 and a second set of three (3) wheels 24. The blade assembly 22 is connected to a strut 26 by a pivotal connection 28 (e.g. pin connection). The strut 26 is provided with a pair of lower gusset plates 30 having a pivotal connection 32 with a leaf spring 34. A single leaf spring 34 is shown, however, the leaf spring 34 can be one that comprises multiple separate or individual leafs mechanically coupled or connected together. An upper end of the strut 26 is connected to a control arm 36 by pivotal connection 38. The control arm 36 is configured to pivot from a position within the sled body 22, and thus, a slot or window 40 in sled body 12 is provided to accommodate such movement of the control arm 36. The struts 26 include an upper externally threaded portion 26a cooperating with a lower internally threaded portion 26b configured to allow the length of the strut 26 to be adjusted.

The back portion of the sled body 12 is provided with a rear suspension 42 connecting a single rear wheel 44 to the sled body 12. The rear wheel 44 is supported by a wheel assembly 46 connected to a swing arm 48 by a pivotal connection 50. The wheel assembly 46 includes a yoke portion 52 provided with a pivotal connection 54 for accommodating an axle of the wheel 44. The wheel assembly 46 is configured to rotate relative to the swing arm 48 and sled body 12, and the pivotal axis is oriented substantially vertical with respect to the sled apparatus 10. A pair of coiled spring/shock absorber assemblies 56 connect the swing arm 48 to the sled body 12.

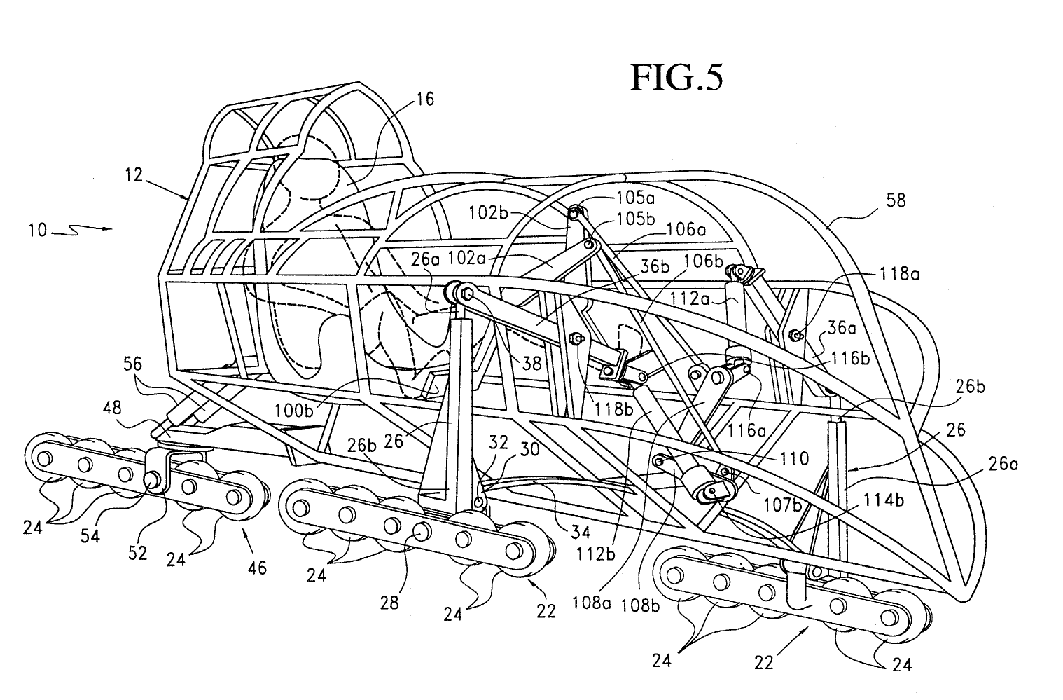

A detailed view of the sled apparatus 10 without an outer skin, covering or shell is shown in FIG. 5.

The sled body 12 of the sled apparatus 10 shown in FIG. 5 is made of a tubular welded frame preferably made of steel, aluminum, titanium, or some suitable metal alloy or even plastic. The frame 58 can be covered with fabric, fiberglass, plastic sheeting, metal sheeting, or a shell made of fiberglass, Kevlar, graphite or other suitable composite can be connected to the frame 58, or the frame 58 can be molded to portions of the shell.

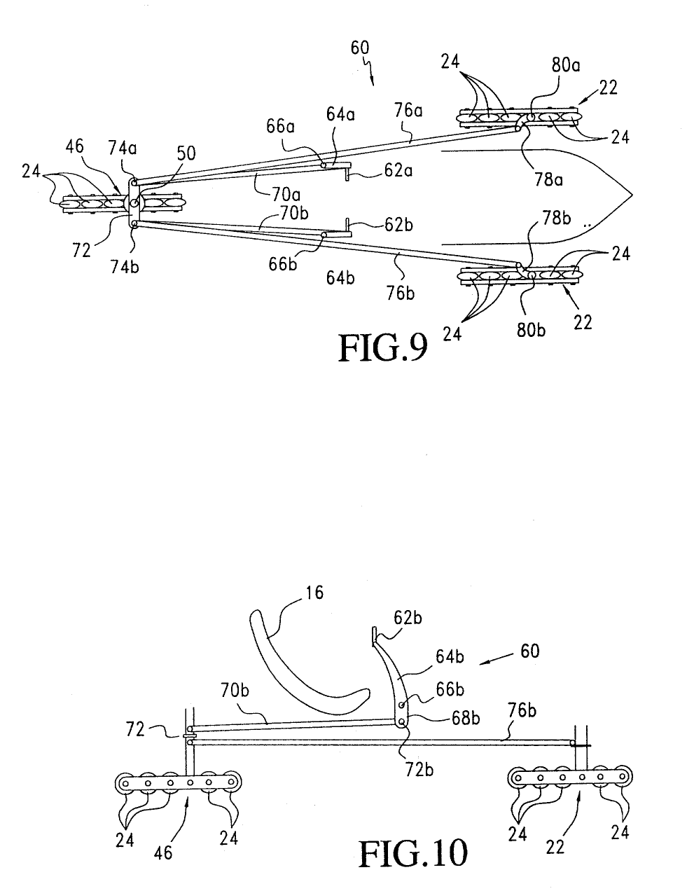

The steering mechanism 60 for the sled apparatus 10, is shown diagrammatically in FIGS. 9 and 10.

The steering mechanism 60 is controlled by a set of handgrips 62a and 62b provided on hand levers 64a and 64b. The hand levers 64a and 64b are connected to outer ends of shafts 66a and 66b pivotally supported by portions of the tubular frame 58 (e.g. gusset plates provided with appropriate type bearings). A pair of push rods 70a and 70b are connected to lower ends of the hand levers 64a and 64b, respectively, and extend and connect to a bell crank 72 by pivotal connection 74a and 74b, respectively to provide steering of the rear wheel assembly 46. The bell crank 72 and wheel assembly 46 again are connected to the swing arm 48 by pivotal connection 50, as shown in FIG. 1.

A pair of push rods 76a and 76b are pivotally connected to the bell crank 72 and extend forward and connect with steering arms 78a and 78b, respectively, of the blade assemblies 22. The blade assemblies 22 are connected to the struts 26 (FIG. 1) by pivotal connections 80a and 80b (FIG. 9), respectively, to provide steering of the blade assemblies 22.

A driver of the sled apparatus 10 grips the handgrip 62a with his or her left hand and grips handgrip 62b with his or her right hand. To turn the sled apparatus 10 to the left, the driver pulls back on the left handgrip 62a and pushes forward on the right handgrip 62b. To turn right, the driver pulls back on the right handgrip 62b and pushes on the left handgrip 62a. In the embodiment shown in FIGS. 9 and 10, the handgrips 62a and 62b are mechanically coupled by the pushrod 70a and 70b to the bellcrank 72 allowing the user to apply both a pulling force and pushing force on the opposite handgrips 62a and 62b greatly increasing the ability of the driver to turn the rear rollerblade type blade assembly 46 for quickly and accurately turning the sled apparatus 10. In an alternative embodiment, the left handgrip 62a and right handgrip 62b can be decoupled, and operate independent of each other however, this arrangement would reduce the amount of turning force by approximately one-half(½) versus the arrangement shown in FIGS. 9 and 10.

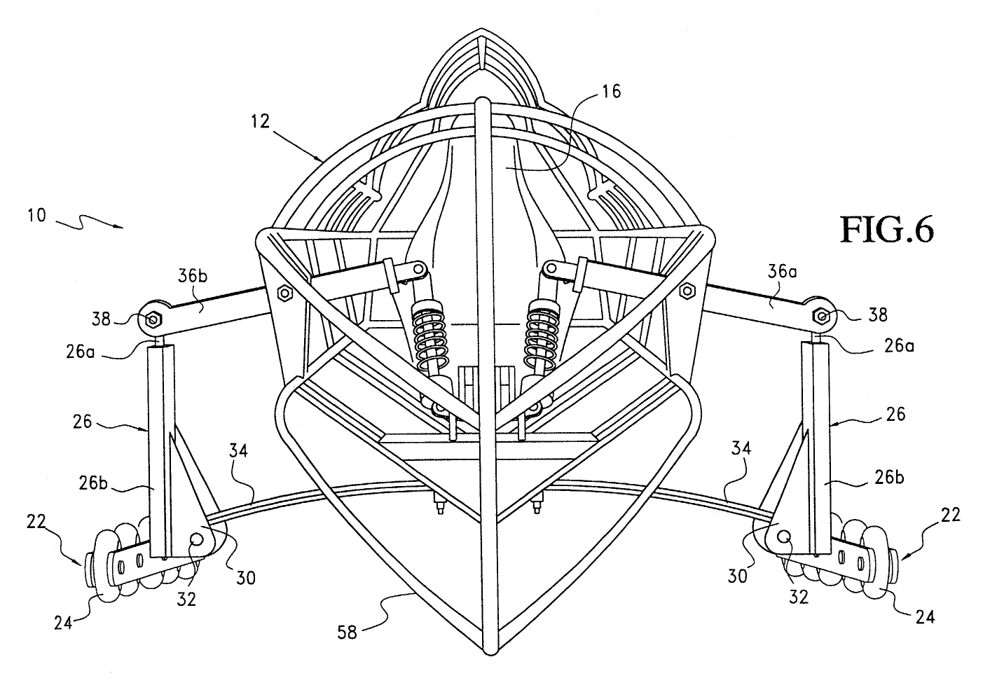

The tilting mechanism for the sled apparatus 10 is shown in FIGS. 5-7 and 12.

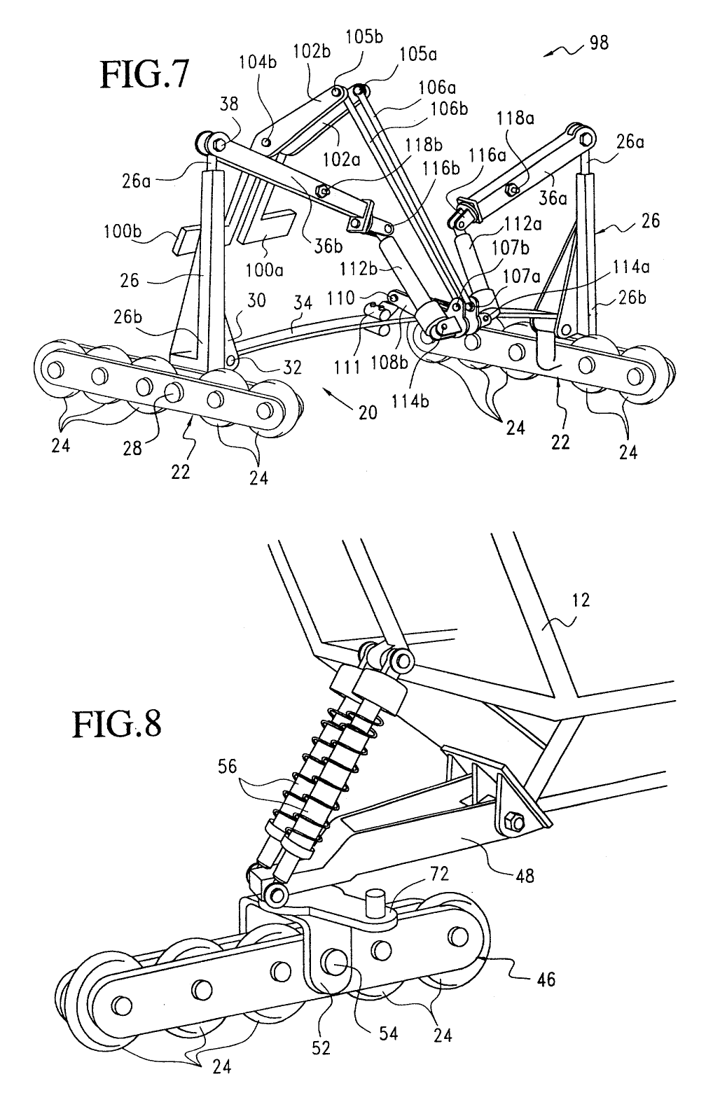

Referring to FIG. 7 and 12, the tilting mechanism 98 includes a set of foot pedals 100a and 100b connected to levers 102a and 102b respectively. The levers 102a and 102b are connected to the frame 12 by pivotal connectors 104a and 104b. The upper ends of the levers 102a and 102b are pivotally connected to pushrods 106a and 106b. The opposite ends of the pushrods 106a and 106b are pivotally connected to stabilizing arms 108a and 108b. The opposite ends of the stabilizing arms 108a and 108b are connected by pivotal connection 110 to a bracket 111 connected to leaf spring 34. A pair of shock absorber/spring assemblies 112a and 112b are connected at their lower ends by pivotal connectors 114a and 114b to stabilize arms 108a and 108b. The upper ends of the shock absorber/spring assemblies 112a and 11 2b are connected by pivotal connectors 116a and 116b respectively, to control arms 36a and 36b. The control arms 36a and 36b are connected to the frame 12 by pivotal connectors 118a and 118b, respectively.

In use, the driver of the sled apparatus 10 tilts the sled apparatus by use of the tilting mechanism 98. Specifically, the user places his or her left foot on foot pedal 100a and his or her right foot on foot pedal 100b. To tilt the sled apparatus 10 along the roll axis of the sled apparatus 10 the driver applies foot pressure to one of the foot pedals 100a or 100b. When the driver applies foot pressure to foot pedal 100a, the tilting mechanism 98 pivots the outer end of the control arm 36a downwardly causing the left side of the sled apparatus 10 upwardly (with reference frame when the driver is sitting within the sled apparatus 10). When the driver applies foot pressure to the foot pedal 100b, the outer end of the control arm 36b is forced downwardly causing the right side of the sled apparatus 10 to move upwardly. It is possible to raise the entire front of the sled apparatus 10 by simultaneously applying foot pressure to both foot pedals 100a and 100b, and then somewhat tilting the sled apparatus 10 by applying differential pressure to the foot pedals 100a and 100b to provide further variability in the operation of the sled apparatus 10.

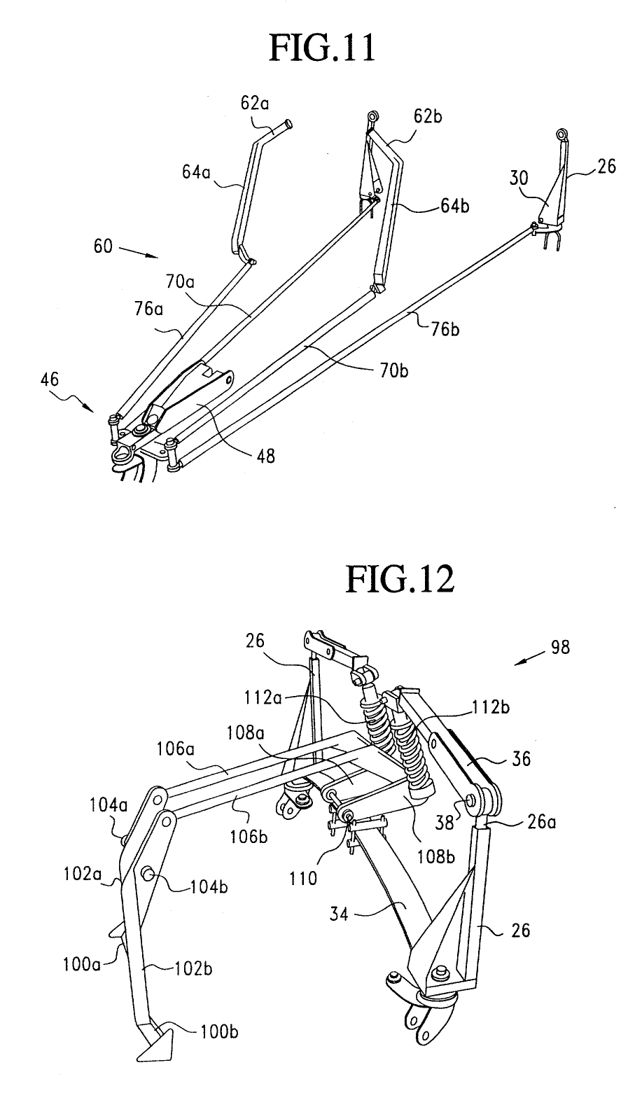

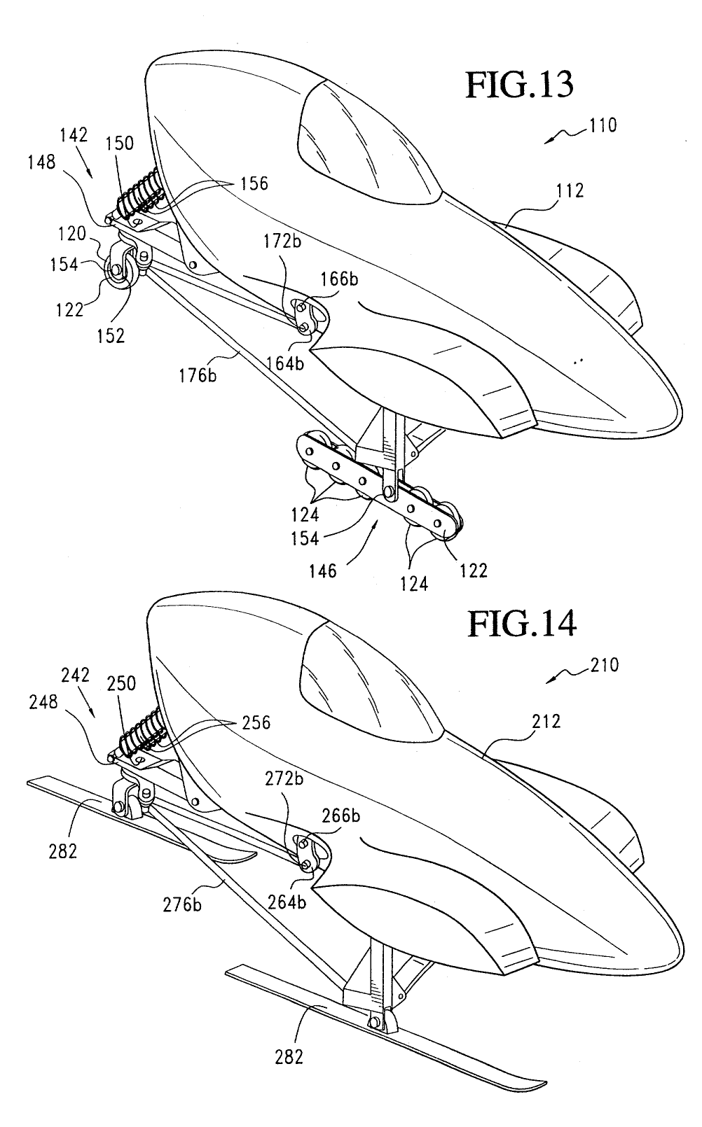

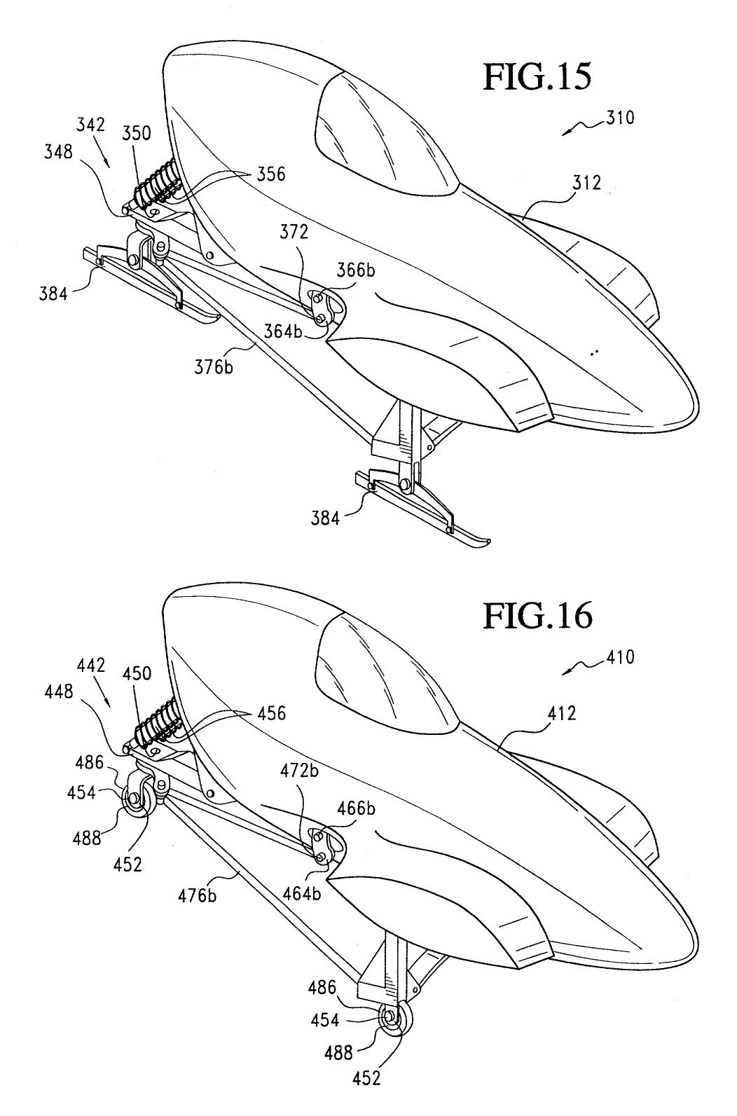

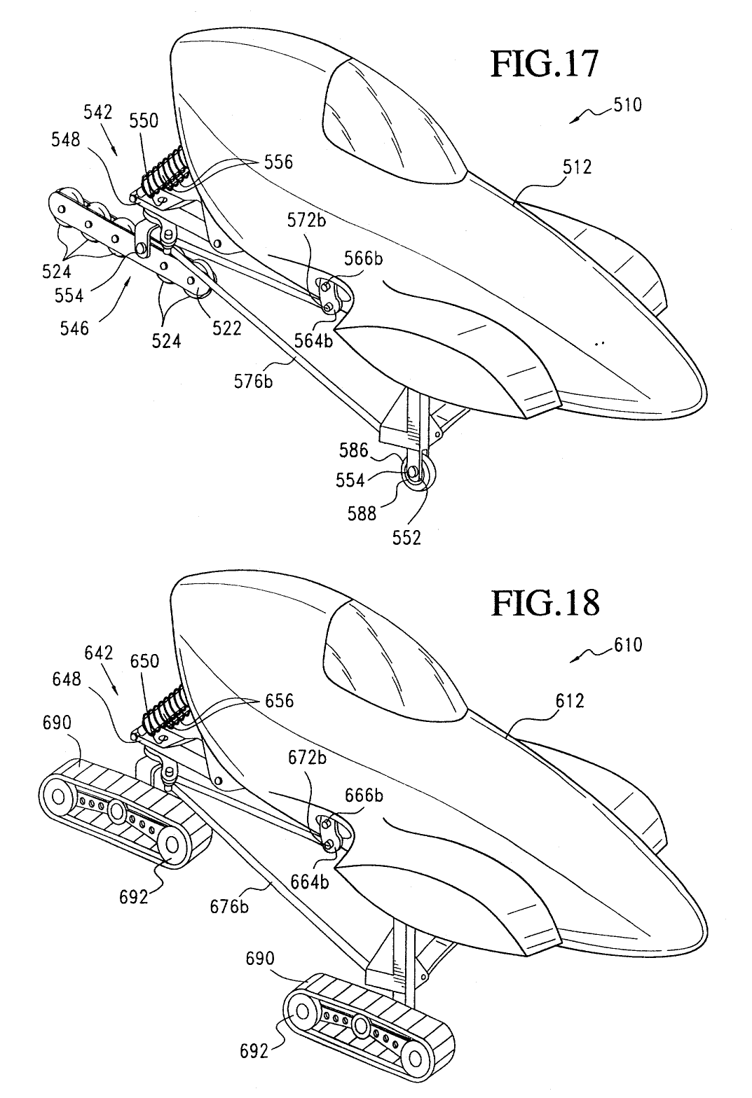

The steering mechanism 60 and tilting mechanism 98 are independently controlled and operated in the sled apparatus 10 shown in FIGS. 1-12. However, in an alternative embodiment, the steering mechanism 60 and tilting mechanism 98 can be partially or fully coupled to provide coordinated steering and tilting of the sled apparatus. However, the independent configuration shown in the sled apparatus 10 of FIGS. 1-12 allows for more variability of operation by the driver depending on the type of surface, the angle of inclination of the surface and/or roughness of the surface. For example, when negotiating the sled apparatus 10 shown in FIG. 1 down a grassy hill, when the driver steers to the left, he or she may want to tilt the sled apparatus 10 downwardly on the lefthand side to put more force or pressure on the right front blade assembly 22 (i.e. the blade assembly 22 on the downhill side of the vehicle) the same or similar to a person snow skiing down a hill. In this manner, the sled apparatus 10 can be operated in a smoother and safer course versus a vehicle not having a tilting mechanism negotiating such a terrain. Thus, the sled apparatus 10 allows for banking of the sled apparatus 10 during turning to allow for faster, more stable and safe turning thereof.

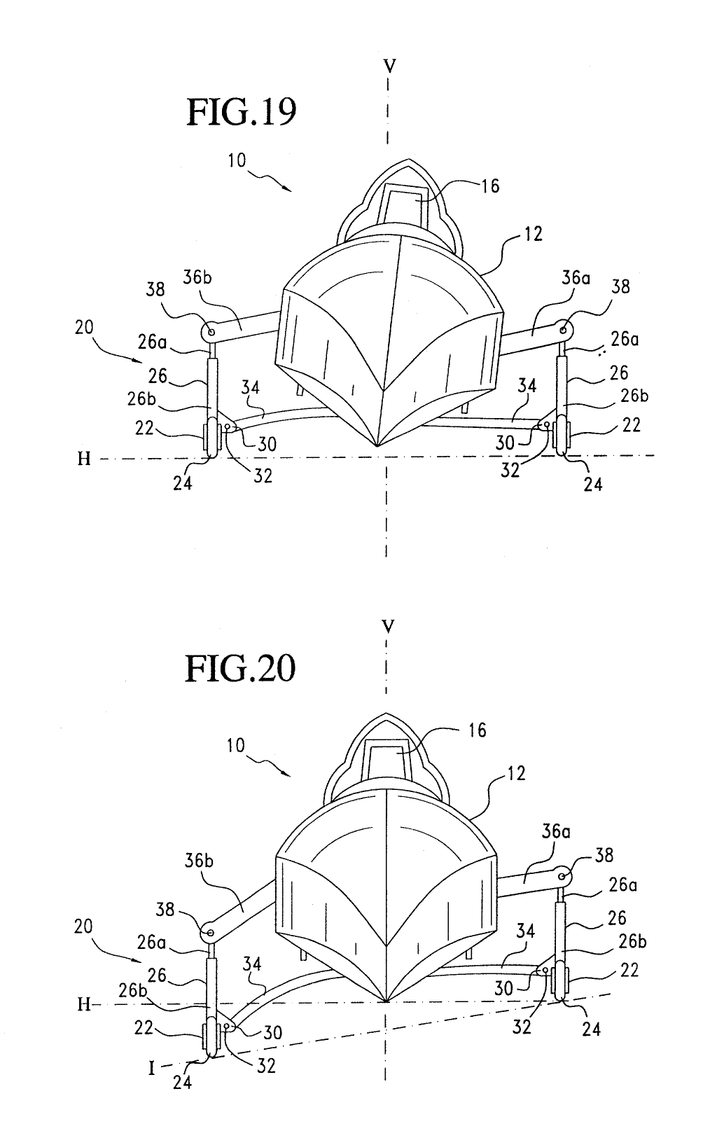

As shown in FIG. 19, the sled apparatus 10 can be tilted when traveling on a substantially horizontal surface H. Specifically, the sled apparatus 10 can be tilted downwardly on the left side thereof when negotiating a turn to the left allowing the sled apparatus 10 to negotiate the turn faster, with more stability and safer. The struts 26 remain substantially vertical with respect to the horizontal surface H, however, in other embodiments, the sled apparatus 10 can be configured to incline the struts 26 to possibly further enhance the turning ability of the sled apparatus 10.

As shown in FIG. 20, the sled apparatus 10 is being driven on an inclined surface I. The sled apparatus 10 is tilted so that the sled apparatus is oriented in a substantially vertical axis as shown. The downhill side of the sled apparatus 10 (i.e. right side) carries a greater percentage of the weight with the sled apparatus 10 being tilted into the hill as shown. This configuration would be achieved, for example, when negotiating a turn of the sled apparatus 10 to the left when coming down a hill and traversing the hill the same or similar to a person snow skiing.

What is claimed is:

1. A sled apparatus for use over a surface, comprising:
a sled body configured to accommodate at least one rider;
a front suspension connected to said sled body;
a rear suspension connect to said sled body;
a front pair of surface contacting members connected to said sled body by said front suspension;
at least one rear surface contacting member connected to said sled body by said rear suspension;
a steering mechanism configured to steer at least one of said surface contacting members; and
a tilting mechanism configured to tilt substantially said sled body along said sled body's roll axis relative to the surface.

2. An apparatus according to claim 1, wherein said steering mechanism and tilting mechanism are configured to be independent.

3. An apparatus according to claim 1, wherein said steering mechanism and tilting mechanism are configured to be dependent.

4. An apparatus according to claim 1, wherein said steering mechanism and tilting mechanism are configured to be selectively independent or dependent.

5. An apparatus according to claim 1, wherein said steering mechanism is actuated and controlled by a pair of foot pedals.

6. An apparatus according to claim 5, wherein said steering mechanism is coupled to said tilting mechanism, and said foot pedals actuate and control both steering and tilting of said apparatus.

7. An apparatus according to claim 6, wherein said steering mechanism is mechanically coupled to said tilting mechanism.

8. An apparatus according to claim 7, wherein said steering mechanism and said tilting mechanism are coupled to have directly proportional movement rates.

9. An apparatus according to claim 7, wherein said steering mechanism and said tilting mechanism are coupled to have differential proportional movement rates.

10. An apparatus according to claim 1, wherein said ground contacting members are snow skis.

11. An apparatus according to claim 1, wherein said ground contacting members are ice skates.

12. An apparatus according to claim 1, wherein said ground contacting members are roller type blades.

13. An apparatus according to claim 1, wherein said tilting mechanism is configured to move a center of gravity of said apparatus in a sideways direction relative a direction of movement of said apparatus.

14. An apparatus according to claim 13, wherein said steering mechanism and said tilting mechanism are coordinated so that said sled body rolls in a same direction as said apparatus is steered by the at least one rider.

15. An apparatus according to claim 1, wherein said sled body is constructed of a tubular frame supporting an outer skin.

16. An apparatus according to claim 1, wherein said rear suspension is a rear independent suspension.

17. An apparatus according to claim 1, wherein said at least one ground contacting member is a single ground contacting member located substantially on center relative to a center longitudinal axis of said apparatus.

18. An apparatus according to claim 17, wherein said rear suspension and said single rear ground contacting member are configured to allow said single rear ground contacting member to freely rotate along a substantially vertical axis.

19. An apparatus according to claim 1, wherein said steering mechanism is configured to rotate said pair of front ground contacting members along substantially vertical axes.

20. An apparatus according to claim 1, wherein said front suspension includes a transverse oriented leaf spring.

21. An apparatus according to claim 1, wherein said rear suspension includes a coil spring.
